(19) United States
(12) Patent Application Publication
(10) Pub. No.: US 2009/0272052 A1
(43) Pub. Date: Nov. 5, 2009

(54) Construction Element and Method for its Manufacture

(76) Inventors: Hallvar Eide, Orskog (NO); Arild Saasen, Hafrsfjord (NO)

Correspondence Address: DENNISON, SCHULTZ & MACDONALD, 1727 KING STREET, SUITE 105, ALEXANDRIA, VA, 22314, US

(21) Appl. No.: 11/919,429

(22) PCT Filed: Apr. 26, 2006
(86) PCT No.: PCT/NO2006/000154

§ 371 Date: Dec. 19, 2007

(30) Foreign Application Priority Data
Apr. 26, 2005 (NO) 20052033

(51) Int. Cl. E04B 2/84; B29C 39/02

(52) U.S. Cl. 52/251; 264/257

(57) ABSTRACT

A construction element for protection of tunnels against fire, comprising two layers (12, 13) with different materials and material qualities, wherein one and outwardly oriented carrier layer (13) has a particularly high strength, while the other and inwardly oriented exposure layer (12) has a material composition adapted to meet particular application-specific conditions, such as high heat. The carrier layer (13) contains aplite as the main cementing agent, and a mat-shaped reinforcement material (14) is embedded in the area between the carrier layer (13) and the exposure layer (12).

The invention relates to a construction element, as stated in the introductory part of claim 1, particularly for the erecting of protective walls in tunnels, and a method of manufacturing such a construction element.

### BACKGROUND

For covering of the sides of rock tunnels, as well as for other purposes, there is a need for a planar construction element of a mineral-bearing casting material. Such construction elements must meet various requirements. This has resulted in the development of construction elements made up of two layers, with each layer having differing qualities.

From German patent application 102 43 253 (Bilfinger Berger AG, 2004) it is known to manufacture a planar construction element with one material quality on one side, and another, differing material quality on the other. As an example of such a construction element, there is mentioned an embodiment with two different concrete qualities and embedded fibre reinforcement.

This structure provides the possibility of adaption of such construction elements for particular purposes. However, there is no teaching of how to manufacture a construction element that meets the requirements applicable to tunnel securing and some other purposes, where long life, density and heat resistance are particularly important requirements.

From Japanese patent publication 72033048 (Shiga-Ken 1972), it is known to manufacture a casting material with aluminous cement as a cementing agent and aplite as the main filling compound. This results in a porous structure and has therefore not been particularly suitable for construction elements that require high strength and long life.

Object

The main object of the invention is to create a construction element made up of layers, which is particularly resistive to external influences, such as heat, water, and frost, and which simultaneously exhibits long-term stability. In addition, it is an object to provide a construction element, in which at least one of the layers is devoid of cracks or pores. It is furthermore an object to provide such a construction element that can be manufactured in a efficient manner, of materials that are easy to process.

The invention

The invention is stated in claim 1. With this composition, one obtains various advantages:
particularly high density
high mechanical strength
long life
high resistivity to fire and other heat loads.

In claims 2-9, particularly advantageous embodiments are stated. The invention also comprises a method of manufacturing such a construction element, as stated in claim 10.

Aplite is a granite rock type that mainly contains quartz and feldspar. Aplite exists inter alia in Montpellier, Va., USA, Owens Valley, Calif., USA, Finnvoll valley in Norway, in Tuscany in Italy, as well as some places in Russia and Japan. Aplite is supplied commersially by inter alia Maffei Natural Resources Italy and from US Silica Company, West Virginia, USA. Aplite typically contains silicon, magnesium, iron, sodium, sodium, potassium, titanium and calcium, however, the most important components are silicon and aluminium (in the form of oxides), which may be present in relative amounts in the range of 60-85 % and 10-25 % by weight, respectively.

In connection with the invention, it is preferred to use an aplite with a quartz content in the range of 60 to 95 percent by weight, more preferred in the range of 68 to 90 percent by weight. It is preferred that the aplite used is a naturally existing aplite. However, the term “aplite” in this specification generally comprises a combination of the most important rock types that are found in naturally existing aplite.

A preferred embodiment of the invention is described below, with reference to the drawings, in which

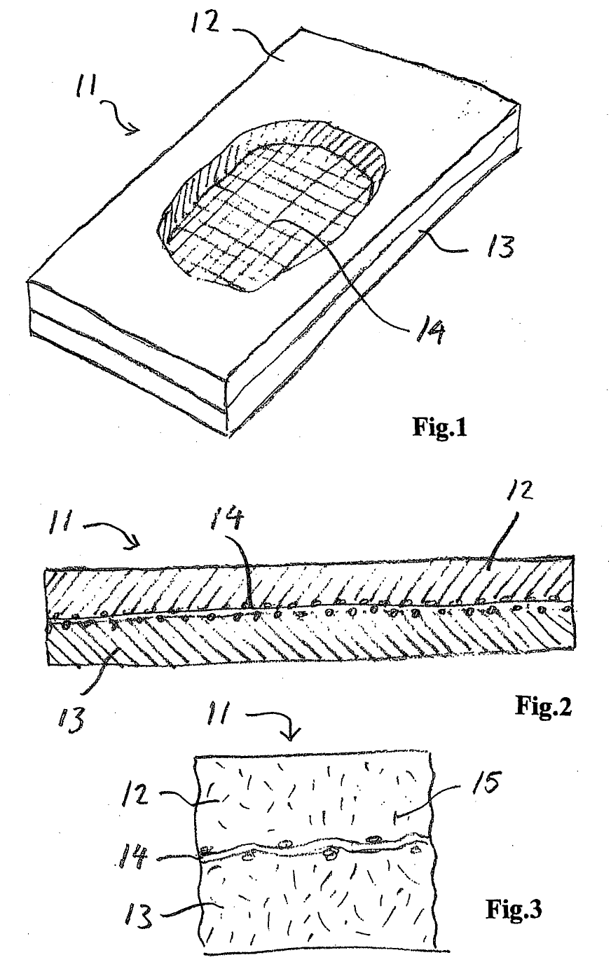

FIG. 1 shows a perspective view of an embodiment of the invention, with a partially cross-sectioned structure;

FIG. 2 shows a cross-section through the construction element of FIG. 1; and

FIG. 3 shows an enlarged section of the construction element of FIG. 2.

A rectangular, planar construction element 11, which is made up of an exposure layer 12 and a carrier layer 13, is shown in the drawings. In the example, each of the two layers constitutes about half of the thickness of the construction element. A reinforcement in the form of a carbon mat 14, which is to partially reinforce the total construction element, is embedded between the two layers.

The construction element 11 can have various proportions and dimensions, adapted to the application in question. It can be provided with a groove running around it, or corresponding groove and tongue, or another edge profile suited for securing the elements together during assembly of a wall, or possibly use together with other construction elements.

In the example, the exposure layer 12 of the construction element 11 is composed of a casting mass with cement and particulate slag from the metalurgical industry and anhydrite. Slag from the smeltery industry, especially from the production of pig iron, is particularly useful. Such slag can be added in granular form. As an alternative to anhydrite, another alkaline element, such as gypsum, can be added. At least one of the layers can advantageously contain up to 20% by weight of micronised calcite (calcium carbonate), by the cement amount.

This is particularly advantageous if micronised aplite is added to the exposure layer, either as the sole or as a main cementing agent. By micronised aplite is meant aplite with a grain size mainly less than 200 microns. Aplite can also be added as a filling compound, then i the form of much larger particles.

This will result in a concrete product where the exposure layer 12 has very high resistance to heat, moist and temperature variations. Coupled with the carrier layer 13, high total strength, density and long life are ensured.

The carrier layer 13 is a casting mass based on micronised aplite as the main cementing agent. With appropriate filling material, this will give the concrete product a very high strength and density. The proposed composition results in minimal formation of scratches that can admit water.

In the carrier layer 13, a part of hydraulic cement can be added, such as Portland cement, for instance 25% by weight. Other hydraulic cements can also be used, in lieu of or in addition to Portland cement, such as pozzolane cements, gypsum cements, aluminous cements, silica cements and slag cements.

For both the exposure layer 12 and the carrier layer 13, carbon fibres 15 can be added to the casting mass, thereby contributing to increased strength. The carbon fibres 15 should be maximum 10 cm long, with application together with coarse aggregate materials, preferably 0.3 to 0.7 cm. Use of such fibres can take place without any particular problems, as more fibres are bound together when mixing. Related to the small transverse diameter, which can be approximately 7 microns, carbon fibres give a particularly good reinforcement.

Suitable carbon fibres in loose form or as a mat, can be provided commercially from Devold AMT AS, N-6030 Langev\dot{a}g.

Manufacturing

The construction element 11 can be cast by means of moulds on a mainly horizontal support. The casting is split by first applying the casting mass for the exposure layer 12. The carbon mat is then arranged on the plastic casting mass. Finally a surfacing coat that is to constitute the carrier layer 13 is applied. To both casting masses carbon fibres 15 can be added during the mixing process to increase the strength.

The construction element according to the invention can also be formed as a receptacle element or as another structural element, for instance for the purpose of storage and/or protecting materials that are to be protected, such as radioactive materials.

The construction element provides particularly good protection against high temperature and can thus be used as protection of tunnels against fire. The carrier layer 13 has a particularly high strength, while the exposure layer 12 has a material composition adapted to exposure to high heat.

1-10. (canceled)

11. A construction element for constructing walls, coatings, partition walls for rooms and channels and other areas where an area or compartment is to be demarcated, especially for protection of tunnels against fire, said element comprising two layers of casting masses of different materials and material qualities, in such way that the one and outwardly oriented carrier layer has a particularly high strength, while the other and inwardly oriented exposure layer has a material composition adapted to meet particular application-specific conditions, such as high heat, characterized in that the carrier layer contains micronized aplite as the main cementing agent.

12. A construction element according to claim 11, wherein a mat-shaped reinforcement material is embedded in the area between the carrier layer and the exposure layer.

13. A construction element according to claim 12, wherein the mat-shaped reinforcement material is carbon fiber.

14. A construction element according to claim 11 wherein at least one of the two layers, carbon fibers are embedded in the casting mass, preferably carbon fiber with a length less than 10 cm.

15. A construction element according to claim 14 wherein the carbon fibers in the exposure layer mainly have a length in the range of 0.3 to 0.7 cm.

16. A construction element according to claim 11 wherein the casting material in the exposure layer contains anhydrite as an aggregate material.

17. A construction element according to claim 11 wherein slag from metal production is added as aggregate material to the casting material in the exposure layer.

18. A construction element according to claim 11 wherein the carrier layer comprises a mixture of micronized aplite and Portland cement, preferably in a weight ratio of 3:1.

19. A construction element according to claim 11 wherein at least one of the layers contains up to 20 percent by weight of micronized calcite, in relation to the amount of cement.

20. A method of manufacturing a construction element for constructing walls, coatings, partition walls for rooms and channels and other areas where an area or compartment is to be demarcated, comprising
filling plastic casting mass for the exposure layer in a mould with a substantially flat bottom;
arranging a carbon mat onto the plastic mass; and
filling in a plastic surfacing layer which is to constitute the carrier layer.
